(19) United States
(12) Patent Application Publication
(10) Pub. No.: US 2005/0167006 A1
(43) Pub. Date: Aug. 4, 2005

(54) Steel sheet for high strength heat shrink band for cathode-ray tube and high strength heat shrink band

(75) Inventors: Nobuko Mineji, Hiroshima (JP); Tadashi Inoue, Hiroshima (JP); Tatsuhiko Hiratani, Okayama (JP); Kenji Tahara, Hiroshima (JP); Noritaka Takahashi, Hiroshima (JP); Hiroaki Kato, Kanagawa (JP); Teruo Takeuchi, Yamanashi (JP); Kenichiro Takayanagi, Kanagawa (JP); Chohachi Sato, Kanagawa (JP); Masamichi Okada, Kanagawa (JP)

Correspondence Address: FRISHAUF, HOLTZ, GOODMAN & CHICK, PC, 220 5TH AVE FL 16, NEW YORK, NY, 10001-7708, US

(73) Assignees: JFE STEEL CORPORATION, Tokyo (JP); Sony Corporation, Tokyo (JP)

(21) Appl. No.: 10/506,260

(22) PCT Filed: Dec. 25, 2003
(86) PCT No.: PCT/JP03/16664

(30) Foreign Application Priority Data
Jan. 6, 2003 (JP) 2003-656
Jan. 6, 2003 (JP) 2003-657
Mar. 18, 2003 (JP) 2003-73167
Mar. 18, 2003 (JP) 73168

(51) Int. Cl. H01F 1/147

(52) U.S. Cl. 148/307

(57) ABSTRACT

A steel sheet for an explosion-proof band contains 0.001 to 0.05% by mass of C, 0.2 to 1% by mass of Si, 0.5 to 2.3% by mass of Mn, 0.02 to 0.12% by mass of P, not higher than 0.005% by mass of 0, not higher than 0.020% by mass of S, and not higher than 0.005% by mass of N, and has not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 10 to 25 μm of an average ferrite grain size, and not lower than 10,000 of an anhysteretic magnetic permeability.

### TECHNICAL FIELD

The present invention relates to a steel sheet for an explosion-proof band having a high mechanical strength, which is used for fastening the peripheral portion of a panel glass in a color cathode ray tube such as a television receiver, particularly, to a steel sheet for an explosion-proof band having a high mechanical strength, which is excellent in the magnetic properties and welding properties or which is low in its deterioration with time of the magnetic properties in addition to the excellent magnetic properties and the excellent welding properties, as well as to an explosion-proof band having a high mechanical strength.

### BACKGROUND ART

In a color cathode ray tube such as a television receiver, the periphery of the panel is fastened by an explosion-proof band (heat shrink band) in order to prevent the panel plane from being deformed or imploded in a concave form by a high vacuum state inside the color cathode ray tube. Further, the explosion-proof band also performs the shielding function from geomagnetism as well as the inner magnetic shield so as to prevent the deviation in the landing position of the electron beam on the phosphor screen caused by the geomagnetism, i.e., so-called “color deviations”.

It was customary in the past to use a steel sheet having a yield strength of about 230 N/mm² for forming the explosion-proof band. However, where such a material is used for forming the explosion-proof band, it is necessary to correct the deformation of the panel plane so as to give rise to the problem that the band is rendered heavy. In order to overcome this difficulty, it is necessary to use a high strength steel sheet having a high mechanical strength so as to decrease the thickness of the explosion-proof band and to improve the magnetic permeability of the steel sheet in view of the magnetic shielding properties.

The technologies satisfying the properties required for the material used for forming the explosion-proof band are disclosed in, for example, Japanese Patent Disclosure (Kokai) No. 2001-40417 and Japanese Patent Disclosure No. 2001-40419. The technologies disclosed in these patent documents permit achieving a high mechanical strength level, i.e., a yield strength not lower than 340 N/mm², which is considered to be effective for decreasing the weight of the panel glass, and an excellent magnetic permeability μ_{0.35} at 27.9 A/m (0.35 Oe), which is not lower than 300.

However, the steel sheet disclosed in each of Japanese Patent Disclosure No. 2001-40417 and Japanese Patent Disclosure No. 2001-40419 quoted above, which certainly permits improving shielding properties from geomagnetism to some extent, fails to improve the shielding properties from geomagnetism to the desired level. It should be noted that, where the explosion-proof band is incorporated into the television receiver as a member of the television receiver, the explosion-proof band is subjected to the slit-forming process and a bending process, followed by applying a spot welding to the explosion-proof band. Then, the peripheral portion of the panel glass is fastened by the explosion-proof band through the expansion process and interference shrink fitting process. Such being the situation, a high reliability of the spot-welded portion, i.e., excellent welding properties, is also required for the explosion-proof band. However, the steel sheet of the alloy composition disclosed in each of Japanese Patent Disclosure No. 2001-40417 and Japanese Patent Disclosure No. 2001-40419 quoted above is not necessarily satisfactory in the welding properties. It follows that required is an explosion-proof band exhibiting further improved magnetic properties and welding properties.

In addition, in the technologies disclosed in the patent documents quoted above, a high mechanical strength is achieved by utilizing the strain aging. It follows that the steel sheet contains some solute carbon and, thus, the deterioration of the magnetic properties caused by the strain aging is unavoidable. Under the circumstances, the steel sheet is required to be small in the deterioration with time of the magnetic properties in addition to the characteristics described above, depending on the use of the steel sheet.

### DISCLOSURE OF THE INVENTION

An object of the present invention is to provide a steel sheet for an explosion-proof band having a high mechanical strength, which exhibits excellent magnetic properties and excellent welding properties, and an explosion-proof band having a high mechanical strength.

Another object of the present invention is provide a steel sheet for an explosion-proof band having a high mechanical strength, which exhibits excellent welding properties and excellent magnetic properties, and which is small in the deterioration with time of the magnetic properties, and an explosion-proof band having a high mechanical strength.

According to a first aspect of the present invention, there is provided a steel sheet for an explosion-proof band having a high mechanical strength and excellent in magnetic properties and welding properties, said steel sheet containing 0.001 to 0.05% by mass of C, 0.2 to 1% by mass of Si, 0.5 to 2.3% by mass of Mn, 0.02 to 0.12% by mass of P, not higher than 0.005% by mass of O, not higher than 0.020% by mass of S, and not higher than 0.005% by mass of N, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 10 to 25 μm of an average ferrite grain size, and not lower than 10,000 of an anhysteretic magnetic permeability.

According to a second aspect of the present invention, there is provided a steel sheet for an explosion-proof band having a high mechanical strength and excellent in magnetic properties and welding properties, said steel sheet containing 0.001 to 0.05% by mass of C, more than 1% by mass to 3% by mass of Si, 0.2 to 2.5% by mass of Mn, 0.02 to 0.12% by mass of P, not higher than 0.005% by mass of O, not higher than 0.020% by mass of S, and not higher than 0.005% by mass of N, and having not lower than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 10 to 25 μm of an average ferrite grain size, and not lower than 10,000 of an anhysteretic magnetic permeability.

According to a third aspect of the present invention, there is provided a steel sheet for an explosion-proof band having a high mechanical strength, excellent in magnetic properties and welding properties, and low in the deterioration with time of the magnetic properties, said steel sheet containing 0.001 to 0.2% by mass of C, 0.2 to 1% by mass of Si, 0.5 to 2.3% by mass of Mn, 0.02 to 0.15% by mass of P, not higher than 0.005% by mass of O, not higher than 0.03% by mass of S, and not higher than 0.01% by mass of N, and having not lower than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500° C. for 60 seconds, and not higher than 90 N/mm² of an aging index AI.

According to a fourth aspect of the present invention, there is provided a steel sheet for an explosion-proof band having a high mechanical strength, excellent in welding properties and magnetic properties, and small in the deterioration with time of the magnetic properties, said steel sheet containing 0.001 to 0.2% by mass of C, 0.2 to 1% by mass of Si, 0.5 to 2.3% by mass of Mn, 0.02 to 0.15% by mass of P, not higher than 0.005% by mass of O, not higher than 0.03% by mass of S, and not higher than 0.01% by mass of N, and 0.0001 to 0.01% by mass of B, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500° C. for 60 seconds, and not higher than 70 N/mm² of an aging index AI.

According to a fifth aspect of the present invention, there is provided a steel sheet for an explosion-proof band having a high mechanical strength, excellent in welding properties and magnetic properties, and low in the deterioration with time of the magnetic properties, said steel sheet containing 0.001 to 0.2% by mass of C, higher than 1% by mass to 3% by mass of Si, 0.2 to 2.5% by mass of Mn, 0.02 to 0.12% by mass of P, not higher than 0.005% by mass of O, not higher than 0.020% by mass of S, and not higher than 0.01% by mass of N, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500° C. for 60 seconds, and not higher than 90 N/mm² of an aging index AI.

According to a sixth aspect of the present invention, there is provided a steel sheet for an explosion-proof band having a high mechanical strength, excellent in welding properties and magnetic properties, and low in the deterioration with time of the magnetic properties, said steel sheet containing 0.001 to 0.2% by mass of C, higher than 1% by mass to 3% by mass of Si, 0.2 to 2.5% by mass of Mn, 0.02 to 0.12% by mass of P, not higher than 0.005% by mass of O, not higher than 0.020% by mass of S, not higher than 0.01% by mass of N, and 0.0001 to 0.01% by mass of B, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500° C. for 60 seconds, and not higher than 70 N/mm² of an aging index AI.

Further, according to a seventh aspect of the present invention, there is provided an explosion-proof band having a high mechanical strength, which is manufactured by using any of the steel sheets defined above.

### BRIEF DESCRIPTION OF THE DRAWING

FIG. 1 is a cross sectional view showing the construction of a color cathode ray tube comprising an explosion-proof band manufactured by using the steel sheet defined in the present invention.

### BEST MODE OF WORKING THE INVENTION

The present invention will now be described more in detail.

As a result of an extensive research conducted in an effort to overcome the above-noted difficulties, the present inventors have found that it is possible to obtain a steel sheet for an explosion-proof band having a high mechanical strength and excellent in the magnetic properties and the welding properties by adjusting appropriately the composition of the steel sheet and by defining the P segregation rate, the average grain size of the ferrite and the anhysteretic magnetic permeability of the steel sheet to fall within specific ranges. The present inventors have also found that it is possible to obtain a steel sheet for an explosion-proof band having a high mechanical strength and small in change with time in the magnetic properties while ensuring excellent welding properties and magnetic properties by adjusting appropriately the composition of the steel sheet and by defining the aging index in addition to the P segregation rate, the average grain size of the ferrite, and the anhysteretic magnetic permeability of the steel sheet to fall within prescribed ranges, so as to arrive at the present invention.

The steel sheet for an explosion-proof band according to a first embodiment of the present invention contains 0.001 to 0.05% by mass of C, 0.2 to 1% by mass of Si, 0.5 to 2.3% by mass of Mn, 0.02 to 0.12% by mass of P, not higher than 0.005% by mass of O, not higher than 0.020% by mass of S, and not higher than 0.005% by mass of N, and has a P segregation rate of not higher than 100% within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 10 to 25 μm of an average ferrite grain size, and an anhysteretic magnetic permeability of not lower than 10,000.

The steel sheet for an explosion-proof band according to a second embodiment of the present invention is equal to that according to the first embodiment of the present invention described above, except that the steel sheet contains higher than 1% by mass to 3% by mass of Si and 0.2 to 2.5% by mass of Mn. The steel sheet according to the second embodiment of the present invention exhibits excellent magnetic properties including satisfactory coercive force characteristics in addition to a high anhysteretic magnetic permeability.

The steel sheet according to the first and second embodiments of the present invention will now be described.

The magnetic properties will now be described first.

In the first and second embodiments of the present invention, the anhysteretic magnetic permeability of the steel sheet is set at a value not lower than 10,000 in order to obtain excellent magnetic shielding properties. The anhysteretic magnetic permeability denotes the value obtained by dividing the value of the residual magnetization after the demagnetization within the geomagnetic field by the value of the geomagnetism, as described in “Electronic Information Communication Institute Magazine Vol. J79-C-11, No. 6, p311˜319, '96.6”. As a result of a systematic survey on the parameters of the magnetic properties providing the optimum index denoting the magnetic shielding properties of the explosion-proof band material, the present inventors have found that a steel sheet having a high magnetic permeability under a low magnetic field (27.9 A/m (0.35 Oe)), which is pointed out as an index in, for example, Japanese Patent Disclosure (Kokai) No. 2001-40417 and Japanese Patent Disclosure No. 2001-40419, does not necessarily have a high anhysteretic magnetic permeability, and that the anhysteretic magnetic permeability, rather than the magnetic permeability under the low magnetic field (27.9 A/m (0.35 Oe)) is adapted for use as an index of the magnetic shielding properties of the band material after the demagnetization under the geomagnetic field. Such being the situation, concerning the magnetic properties required for achieving a satisfactory magnetic shielding properties, the anhysteretic magnetic permeability is defined to be not lower than 10,000 in each of the first and second embodiments of the present invention. The steel sheet according to the second embodiment of the present invention, which satisfies the requirement in respect of the anhysteretic magnetic permeability noted above, also exhibits good coercive force properties as other magnetic properties.

The composition of the steel sheet will now be described.

C: If the C content of the steel sheet is lower than 0.001% by mass, the mechanical strength of the welded portion of the steel sheet is not improved relative to the base material and, thus, the welding properties are not improved to reach a desired level. On the other hand, if the C content exceeds 0.05% by mass, the magnetic properties required for the first embodiment of the present invention are not obtained in the case where the Si content is as defined in the first embodiment. Also, if the C content exceeds 0.05% by mass in the second embodiment, the coercive force of the raw material far exceeds the maximum demagnetization magnetic field (170 A/m) produced by a reasonable demagnetization circuit acting on the explosion-proof band, with the result that the demagnetization is rendered insufficient and, thus, the proper magnetic shielding properties cannot be obtained. Such being the situation, the C content is defined in the present invention to fall within a range of between 0.001 and 0.05% by mass. In view of the effect of improving the magnetic properties, it is more desirable for the C content to be not higher than 0.03% by mass, furthermore desirably to be not higher than 0.02% by mass.

Si: Si serves to improve the magnetic properties and to increase the mechanical strength of the steel sheet. In the first embodiment of the present invention, the Si content is defined to fall within a range of between 0.2 and 1% by mass. If the Si content is lower than 0.2% by mass, it is difficult to obtain not lower than 10,000 of the anhysteretic magnetic permeability. On the other hand, if the Si content exceeds 1% by mass, the welding properties tend to be deteriorated, resulting in failure to obtain the welding properties aimed at in the first embodiment of the present invention. In the second embodiment of the present invention, the Si content is defined to fall within a range of between the value of more than 1% by mass and 3% by mass. If the Si content is not higher than 1% by mass, it is difficult to obtain the magnetic properties aimed at in the second embodiment. Also, if the Si content exceeds 3% by mass, the welding properties are deteriorated.

Mn: Mn is a desirable additive element that serves to increase the mechanical strength and to improve the welding properties. In the first embodiment of the present invention, the Mn content is defined to fall within a range of between 0.5 and 2.3% by mass. If the Mn content is lower than 0.5% by mass in the composition according to the first embodiment of the present invention, it is difficult to obtain the effects of increasing the mechanical strength and improving the welding properties. On the other hand, if the Mn content exceeds 2.3% by mass, it is difficult to obtain not lower than 10,000 of the anhysteretic magnetic permeability. In the second embodiment of the present invention, the Mn content is defined to fall within a range of between 0.2 and 2.5% by mass. If the Mn content is lower than 0.2% by mass in the composition defined in the second embodiment, it is difficult to obtain the effects of increasing the mechanical strength and improving the welding properties. On the other hand, if the Mn content exceeds 2.5% by mass, it is difficult to obtain the magnetic properties including not lower than 10,000 of the anhysteretic magnetic permeability and lower than 240 A/m of the coercive force.

P: It is desirable to add P because P serves to increase the mechanical strength of the steel sheet. If the P content is lower than 0.02% by mass, however, the effect produced by the P addition is rendered insufficient. On the other hand, if the P content exceeds 0.12% by mass, the welding properties and the magnetic properties of the steel sheet are deteriorated. Such being the situation, the P content is defined to fall within a range of between 0.02 and 0.12% by mass in each of the first and second embodiments of the present invention.

O: The O content should be lowered in order to obtain desired magnetic properties. If the O content exceeds 0.005% by mass, it is impossible to obtain the desired magnetic properties in each of the first and second embodiments of the present invention. Naturally, the upper limit of the O content should be set at 0.005% by mass.

S: The S content should be lowered in order to obtain the desired magnetic properties in the present invention. If the S content exceeds 0.020% by mass, it is impossible to obtain the desired magnetic properties in any of the first and second embodiments of the present invention. Naturally, the upper limit of the S content should be set at 0.020% by mass. It is more desirable for the S content to be not higher than 0.01% by mass.

N: The N content should be lowered in order to obtain the desired magnetic properties in the present invention. If the N content exceeds 0.005% by mass, it is impossible to obtain the desired magnetic properties in any of the first and second embodiments of the present invention. Naturally, the upper limit of the N content should be set at 0.005% by mass. It is more desirable for the N content to be not higher than 0.003% by mass.

The P segregation rate within the steel sheet will now be described.

In order to obtain good welding properties in each of the first and second embodiments of the present invention, it is absolutely necessary to control the P segregation rate within the steel sheet to fall within a specified range. To be more specific, in order to enhance the welding properties to a satisfactory level aimed at in the present invention within the range of the chemical composition of the steel sheet described above, it is necessary for the P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, to be not higher than 100%.

For obtaining the P segregation rate, the linear analysis of P is performed in the thickness direction in a cross section in the rolling direction of a steel sheet sample by EPMA (Electron Probe Micro Analyzer). The P segregation rate can be obtained by the calculation formula given above, in which Pₐᵥₑ denotes the average concentration of P and Pₘₐₓ denotes the maximum concentration of P in the P segregated portion, which are included in the data obtained by the linear analysis of P noted above.

The average grain size of the ferrite of the steel sheet will now be described.

In order to obtain the mechanical strength and the magnetic properties aimed in each of the first and second embodiments of the present invention, it is necessary for the average grain size of the ferrite to fall within a range of between 10 and 25 μm. If the average grain size of the ferrite is smaller than 10 μm, it is impossible to obtain sufficient magnetic properties. On the other hand, if the average grain size exceeds 25 μm, it is impossible to obtain the desired mechanical strength. Such being the situation, the average grain size of the ferrite should fall within a range of between 10 and 25 μm.

For obtaining the grain size of the ferrite, the grain size is caused to come into view by the nital etching and, then, a micrograph of the grain size is obtained. The grain size of the ferrite is obtained by the intercept method, in which a straight line having a known length is drawn, and the number of grains crossing the straight line is counted, by using the micrograph thus obtained.

Third to sixth embodiments of the present invention will now be described.

The steel sheet for an explosion-proof band according to a third embodiment of the present invention is featured in that the steel sheet contains 0.001 to 0.2% by mass of C, 0.2 to 1% by mass of Si, 0.5 to 2.3% by mass of Mn, 0.02 to 0.15% by mass of P, not higher than 0.005% by mass of O, not higher than 0.03% by mass of S, and not higher than 0.01% by mass of N, and has not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500° C. for 60 seconds, and not larger than 90 N/mm² of an aging index AI.

The steel sheet for an explosion-proof band according to a fourth embodiment of the present invention contains 0.0001 to 0.01% by mass of B in addition to the components specified in the third embodiment, and the steel sheet has not larger than 70 N/mm² of the aging index AI.

The steel sheet for an explosion-proof band according to a fifth embodiment of the present invention is equal to the steel sheet according to the third embodiment, except that the steel sheet for the fifth embodiment contains higher than 1% by mass to 3% by mass of Si, 0.2 to 2.5% by mass of Mn and 0.02 to 0.12% by mass of P.

The steel sheet for an explosion-proof band according to a sixth embodiment of the present invention contains 0.0001 to 0.01% by mass of B in addition to the components specified in the fifth embodiment, and the steel sheet has not larger than 70 N/mm² of the aging index AI.

The steel sheet according to any of the third to sixth embodiments of the present invention is excellent in the welding properties and the magnetic properties. In addition, the steel sheet permits suppressing the deterioration with time of the magnetic properties.

Concerning the magnetic properties of the steel sheet in these embodiments, the anhysteretic magnetic permeability of the steel sheet after the heating at 500° C. for 60 seconds is set at a level not lower than 7,000 in order obtain excellent magnetic shielding properties. The steel sheet according to each of the fifth and sixth embodiments of the present invention, which satisfies the anhysteretic magnetic permeability noted above, also exhibits satisfactory coercive force properties as other magnetic properties.

Concerning the composition of the steel sheet, the third to sixth embodiments commonly differ from the first and second embodiments in that the C content falls within a range of between 0.001 and 0.2% by mass and that the N content is not higher than 0.01% by mass in the third to sixth embodiments. Also, the third and fourth embodiments differ from the fifth and sixth embodiments in the amounts of Si, Mn, P and S contained in the steel sheet.

In the third to sixth embodiments of the present invention, the C content falls within a range of between 0.001 and 0.2% by mass as described above. If the C content is lower than 0.001% by mass, the mechanical strength of the welded portion of the steel sheet is not improved relative to the base material, with the result that the welding properties are not improved to a desired level. On the other hand, if the C content exceeds 0.2% by mass, the deterioration with time of the magnetic properties is promoted, resulting in failure to obtain a steel sheet small in the deterioration with time of the magnetic properties. In other words, it is impossible to obtain the steel sheet aimed at in the third to sixth embodiments of the present invention. Also, if the C content exceeds 0.2% by mass in the fifth and sixth embodiments of the present invention, the coercive force of the raw material far exceeds the maximum demagnetization magnetic field of 170 A/m, which is produced by a reasonable demagnetization circuit acting on the explosion-proof band. It follows that the demagnetization is rendered insufficient, resulting in failure to obtain the proper magnetic shielding performance.

In the third and fourth embodiments of the present invention, the Si content of the steel sheet is defined to fall within a range of between 0.2 and 1% by mass as in the first embodiment. Also, in fifth and sixth embodiments of the present invention, the Si content of the steel sheet is defined to fall within a range of between a value larger than 1% by mass and 3% by mass as in the second embodiment. The reasons for defining the Si content in the third to sixth embodiments are as described previously in conjunction with the first and second embodiments.

In the third and fourth embodiments of the present invention, the Mn content of the steel sheet is defined to fall within a range of between 0.5 and 2.3% by mass as in the first embodiment. Also, in fifth and sixth embodiments of the present invention, the Mn content of the steel sheet is defined to fall within a range of between 0.2 and 2.5% by mass as in the second embodiment. The reasons for defining the Mn content in the third to sixth embodiments are as described previously in conjunction with the first and second embodiments.

The P content is defined to fall within a range of between 0.02 and 0.15% by mass in each of the third and fourth embodiments of the present invention, which differs from the first and second embodiments described previously. However, the P content is defined to fall within a range of between 0.02 and 0.12% by mass in each of the fifth and sixth embodiments of the present invention, as in the first and second embodiments. In each of the third and fourth embodiments, the P content up to 0.15% by mass is acceptable in view of the welding properties of the steel sheet.

The upper limit of the O content is set at 0.005% by mass in each of the third to sixth embodiments of the present invention as in the first and second embodiments in view of the effect of obtaining the desired magnetic properties.

The upper limit of the S content is defined in view of the magnetic properties. To be more specific, in the third and fourth embodiments of the present invention, the upper limit of the S content is set at 0.03% by mass, which differs from that in the first and second embodiments. In the fifth and sixth embodiments of the present invention, however, the upper limit of the S content is set at 0.02% by mass as in the first and second embodiments. It is more desirable for the S content of the steel sheet to be not higher than 0.01% by mass.

The N content of the steel sheet should be low in view of the magnetic properties of the steel sheet. To be more specific, in the third to sixth embodiments of the present invention, the upper limit of the N content is set at 0.01% by mass, which differs from that in the first and second embodiments, in view of the effect of obtaining the desired magnetic properties. It is more desirable for the N content to be not higher than 0.005% by mass.

In the fourth and sixth embodiments of the present invention, the steel sheet also contains B in an amount of 0.0001 and 0.01% by mass in addition to the components described above. Boron (B) is effective for suppressing the deterioration with time of the magnetic properties and, thus, it is effective to add B in the case where it is desirable to further suppress the deterioration with time of the magnetic properties. As described above, the B content of the steel sheet should fall within a range of between 0.0001 and 0.01% by mass. If the B content is lower than 0.0001% by mass, it is impossible to obtain the particular effect. On the other hand, if the B content exceeds 0.01% by mass, B is segregated in the grain boundary in the steel sheet of the present invention, resulting in failure to obtain the magnetic properties desired in the present invention.

In the third to sixth embodiments of the present invention, the P segregation rate within the steel sheet is defined exactly as in the first and second embodiments described previously.

In order to obtain the mechanical strength and the magnetic properties aimed at in the third to sixth embodiments of the present invention, it is necessary for steel sheet to have the average grain size of the ferrite at 5 to 25 μm, which differs from the first and second embodiments described previously. If the average grain size of the ferrite is smaller than 5 μm, it is impossible to obtain the magnetic properties aimed at in these embodiments. On the other hand, if the average grain size of the ferrite exceeds 25 μm, it is impossible to obtain a prescribed mechanical strength. Such being the situation, the average grain size of the ferrite is defined to fall within a range of between 5 and 25 μm in the third to sixth embodiments of the present invention.

In the third to sixth embodiments of the present invention, the aging index AI is also defined in addition to the parameters described above. The aging index AI will now be described.

The degree of deterioration with time of the magnetic properties is affected by the value of the aging index AI. Therefore, the aging index AI is defined to fall within a prescribed range in the present invention in order to suppress the deterioration with time of the magnetic properties. To be more specific, the deterioration with time of the magnetic properties (anhysteretic magnetic permeability) is promoted if the aging index AI exceeds 90 N/mm² as shown in Examples described herein later. However, the deterioration with time of the magnetic properties (anhysteretic magnetic permeability) can be lowered to a desired level if the aging index AI is not larger than 90 N/mm². Such being the situation, the aging index AI is defined to be not larger than 90 N/mm² in the third to sixth embodiments of the present invention. The value of the aging index AI can be further decreased to a level not larger than 70 N/mm² by adding an appropriate amount of B as in the fourth and sixth embodiments of the present invention so as to make it possible to further suppress the deterioration with time of the magnetic properties.

An example of the method of manufacturing a steel sheet according to each embodiment of the present invention will now be described.

Specifically, a steel having the composition described above is smelted, followed by applying a continuous casting to the resultant steel so as to obtain a slab. In the continuous casting stage, an electromagnetic stirring and/or a casting under a low pressure is applied. Then, the slab is heated at a temperature not higher than 1200° C., followed by starting a rough rolling and finishing the hot rolling at 830 to 890° C. After cooling, the hot rolled sheet is wound up at 620 to 680° C., followed by applying a hot rolled sheet annealing to the hot rolled sheet at 680 to 720° C., as desired. It is also possible to apply a temper rolling before the annealing process. Further, the hot rolled coil thus obtained is pickled, followed by cold-rolling. Still further, a continuous annealing or a box annealing is applied to the cold rolled coil at 700 to 850° C. so as to obtain a steel sheet according to each embodiment of the present invention.

In the present invention, it is possible to apply a Zn series plating such as an electrolytic Zn—Ni plating (having a coverage of, for example, about 20 g/m²) by passing the steel sheet thus obtained through an electroplating line in order to impart a corrosion resistance to the steel sheet. In addition, it is also possible to form a film on the surface of the steel sheet so as to improve the corrosion resistance or the heat resistance of the steel sheet.

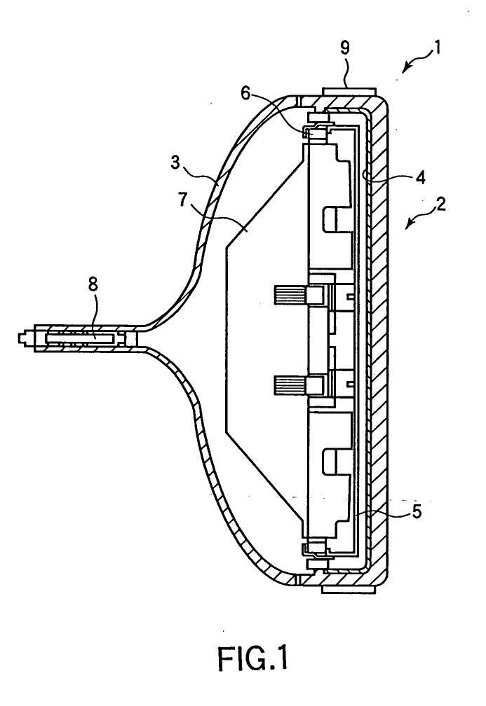

The steel sheet according to each embodiment of the present invention is used for forming an explosion-proof band. FIG. 1 is a cross sectional view showing the construction of a color cathode ray tube 1 comprising an explosion-proof band formed of a steel sheet of the present invention. As shown in FIG. 1, the cathode ray tube 1 comprises a panel portion 2 for displaying an image and a funnel portion 3. The panel portion 2 and the funnel portion 3 are welded to each other by the fusion bonding so as to maintain a high vacuum inside the cathode ray tube 1. A phosphor screen 4 coated with fluorescent substances emitting red, green and blue phosphors is arranged on the inner surface of the panel portion 2, and a tension mask 5 is arranged to face the phosphor screen 4. The tension mask 5 is stretched by a frame 6, and a color selecting electrode is formed by these tension mask 5 and the frame 6. An inner magnetic shield 7 is arranged on the back side of the frame 6. Also, an explosion-proof band 9 formed of the steel sheet of the present invention is arranged to surround the periphery of the panel portion 2 such that the panel portion 2 is fastened by the explosion-proof band 9. Incidentally, a reference numeral 8 denotes an electron gun.

### EXAMPLES

Examples of the present invention will now be described by comparison with comparative examples.

### First Example

Each of steel samples Nos. 1 to 6 having a chemical composition as shown in Table 1 was smelted and, then, was cast into a slab. An electromagnetic stirring was performed in the casting stage. The slab thus prepared was hot-rolled so as to obtain a hot rolled coil having a thickness of 2.8 mm. The finish rolling temperature was set at 870° C. Also, the wind-up temperature after the finish rolling was set at 680° C. Incidentally, the electromagnetic stirring was not performed in the casting stage of sample No. 4.

A hot rolled sheet annealing was applied at 700° C. to the hot rolled coil thus obtained, followed by applying an acid pickling, then, a cold rolling so as to obtain a cold rolled steel sheet having a thickness of 1.0 mm. The cold rolled steel sheet thus obtained was annealed at 700° C. for 60 seconds so as to obtain a steel sheet sample.

A sample was cut out of the steel sheet sample thus obtained so as to measure the yield strength and the anhysteretic magnetic permeability. The anhysteretic magnetic permeability was measured when a demagnetization process was performed by superimposing an offset magnetic field of 27.9 A/m (0.35 Oe). Specifically, the anhysteretic magnetic permeability was measured as follows:

1) An attenuating AC current is allowed to flow through the primary coil so as to demagnetize completely the ring test piece.

2) An attenuating AC current is allowed to flow again through the primary coil so as to demagnetize the test piece under the state that a DC bias magnetic field of 27.9 A/m (0.35 Oe) is generated by allowing a DC current to flow through a tertiary coil.

3) The test piece is excited by allowing a current to flow through the primary coil, and the B-H curve is measured by detecting the generated magnetic flux by a secondary coil.

4) The anhysteretic magnetic permeability is calculated from the B-H curve.

The welding properties of the steel sheet sample were evaluated by applying a spot welding to four annealed steel sheets superposed one upon the other. The welding was performed by using in combination electrodes of F-type and DR-type each having a diameter at the tip of 6 mm under a welding current of 7.0 kA, a power supply time of 0.5 second (30 cycles/60 Hz), and a pressurizing force of 5,880 N. After the welding, a peeling test, in which two annealed steel sheets in the welded portion were collectively peeled, was conducted, with the result as shown in Table 2. The evaluation of the welding properties is indicated by a mark “x” indicating poor welding properties, i.e., the occurrence of a peel fracture within the welded portion, and by another mark “◯” indicating good welding properties, i.e., the occurrence of a plug fracture in the vicinity of the welding portion of the base material portion.

Table 2 also shows the results of evaluations of the yield strength (YS) and the anhysteretic magnetic permeability together with the result of evaluation of the welding properties.

As shown in Table 2, each of steel sheet samples Nos. 1, 2, 3 and 6 having the composition, the P segregation rate and the texture falling within the ranges defined in the first embodiment of the present invention exhibited a yield strength not lower than 340 N/mm² and an anhysteretic magnetic permeability not lower than 10,000. As a result, these steel sheet samples were found to be satisfactory in each of the magnetic shielding properties and the welding properties. On the other hand, steel sheet sample No. 4 had the P segregation rate exceeding the upper limit defined in the present invention and steel sheet sample No. 5 had the P content exceeding the upper limit defined in the present invention. Such being the situation, these steel sheet samples were found to be inferior in at least one of the magnetic properties and the welding properties. Particularly, each of the steel sheet samples Nos. 1 to 3 had the C content falling within a preferred range among the samples of the present invention and, thus, exhibited particularly excellent magnetic properties.

As pointed out above, it has been confirmed that a steel sheet exhibiting an expected yield strength, an expected anhysteretic magnetic permeability and expected welding properties can be provided in the case of satisfying the required constituents of the present invention defined in the first embodiment of the present invention.

TABLE 1

| | | | | | | | | P | Ferrite | |
|---|---|---|---|---|---|---|---|---|---|---|
| | | | | | | | | Segregation | Grain | |
| | Chemical Composition (mass %) | | | | | | | Rate | Size | |
| No. | C | Si | Mn | S | P | O | N | (%) | (μm) | Remarks |
| 1 | 0.0022 | 0.50 | 2.30 | 0.005 | 0.075 | 0.0020 | 0.0026 | 50 | 10 | Present |
| | | | | | | | | | | Invention |
| 2 | 0.0151 | 0.51 | 0.98 | 0.006 | 0.073 | 0.0021 | 0.0020 | 31 | 15 | Present |
| | | | | | | | | | | Invention |
| 3 | 0.0085 | 0.95 | 1.63 | 0.008 | 0.060 | 0.0015 | 0.0031 | 35 | 12 | Present |
| | | | | | | | | | | Invention |
| 4 | 0.0021 | 0.55 | 2.24 | 0.007 | 0.083 | 0.0023 | 0.0026 | 110 | 10 | Comparative |
| | | | | | | | | | | Example |
| 5 | 0.0023 | 0.52 | 2.11 | 0.007 | 0.131 | 0.0017 | 0.0014 | 90 | 13 | Comparative |
| | | | | | | | | | | Example |
| 6 | 0.045 | 0.97 | 1.60 | 0.008 | 0.065 | 0.0018 | 0.0030 | 40 | 10 | Present |
| | | | | | | | | | | Invention |

TABLE 2

| | | Anhysteretic | | |
|---|---|---|---|---|
| | YS | Magnetic | Welding | |
| No. | (N/mm²) | Permeability | Properties | Remarks |
| 1 | 410 | 14,900 | ◯ | Present |
| | | | | Invention |
| 2 | 341 | 13,500 | ◯ | Present |
| | | | | Invention |
| 3 | 400 | 14,000 | ◯ | Present |
| | | | | Invention |
| 4 | 415 | 14,500 | X | Comparative |
| | | | | Example |
| 5 | 435 | 9,000 | X | Comparative |
| | | | | Example |
| 6 | 415 | 10,000 | ◯ | Present |
| | | | | Invention |

### Second Example

Each of steel samples Nos. 11 to 19 having a chemical composition as shown in Table 3 was smelted and, then, was cast into a slab. An electromagnetic stirring was performed in the casting stage. The slab thus prepared was hot-rolled so as to obtain a hot rolled coil having a thickness of 2.8 mm. The finish rolling temperature was set at 870° C. Also, the wind-up temperature after the finish rolling was set at 680° C. Incidentally, the electromagnetic stirring was not performed in the casting stage of sample No. 7.

A hot rolled sheet annealing was applied at 700° C. to the hot rolled coil thus obtained, followed by applying an acid pickling and, then, a cold rolling so as to obtain a cold rolled steel sheet having a thickness of 1.0 mm. The cold rolled steel sheet thus obtained was annealed at 700° C. for 60 seconds so as to obtain a steel sheet sample.

A sample was cut out of the steel sheet sample thus obtained so as to measure the yield strength as well as the anhysteretic magnetic permeability and the coercive force. The anhysteretic magnetic permeability was measured when a demagnetization process was performed by superposing an offset magnetic field of 27.9 A/m (0.35 Oe). The anhysteretic magnetic permeability was measured as in the first Example.

The welding properties were also evaluated in respect of the steel sheet sample. For evaluating the welding properties, four annealed steel sheets were superposed one upon the other, and a spot welding was applied to the superposed structure as in the first Example so as to evaluate the welding properties on the basis equal to that in the first Example.

Table 4 shows the results of measurement of the yield strength (YS), the anhysteretic magnetic permeability and the coercive force as well as the result of evaluation of the welding properties.

As shown in Table 4, each of the steel sheet samples Nos. 11 to 15 had a composition, the P segregation rate, and the texture falling within the ranges specified in the second embodiment of the present invention. Also, each of these steel sheet samples, which exhibited a yield strength not lower than 340 N/mm², an anhysteretic magnetic permeability not lower than 10,000 and a coercive force smaller than 240 A/m, exhibited satisfactory magnetic shielding properties and was satisfactory in the welding properties as shown in Table 4. On the other hand, at least one of the magnetic properties and the welding properties was unsatisfactory in each of sample No. 16 having a Si content exceeding the upper limit defined in the second embodiment of the present invention, sample No. 17 having a P segregation rate exceeding the upper limit specified in the present invention, sample No. 18 having a P content exceeding the upper limit specified in the present invention, and sample No. 19 having a C content exceeding the upper limit specified in the second embodiment of the present invention.

As pointed out above, it has been confirmed that a steel sheet exhibiting an expected yield strength, expected magnetic properties (anhysteretic magnetic permeability and coercive force) and expected welding properties can be provided in the case of satisfying the required constituents of the present invention defined in the second embodiment of the present invention.

TABLE 3

| | | | | | | | | P | Ferrite | |
|---|---|---|---|---|---|---|---|---|---|---|
| | | | | | | | | Segregation | Grain | |
| | Chemical Composition (mass %) | | | | | | | Rate | Size | |
| No. | C | Si | Mn | S | P | O | N | (%) | (μm) | Remarks |
| 11 | 0.0145 | 1.3 | 2.21 | 0.005 | 0.081 | 0.0015 | 0.0023 | 35 | 15 | Present |
| | | | | | | | | | | Invention |
| 12 | 0.0210 | 1.3 | 2.23 | 0.005 | 0.080 | 0.0018 | 0.0021 | 30 | 14 | Present |
| | | | | | | | | | | Invention |
| 13 | 0.0074 | 1.8 | 1.90 | 0.006 | 0.063 | 0.0022 | 0.0019 | 45 | 19 | Present |
| | | | | | | | | | | Invention |
| 14 | 0.0051 | 1.8 | 1.90 | 0.008 | 0.062 | 0.0013 | 0.0025 | 50 | 21 | Present |
| | | | | | | | | | | Invention |
| 15 | 0.0068 | 2.8 | 0.50 | 0.008 | 0.030 | 0.0013 | 0.0025 | 30 | 20 | Present |
| | | | | | | | | | | Invention |
| 16 | 0.0032 | 3.2 | 0.25 | 0.006 | 0.024 | 0.0011 | 0.0015 | 20 | 23 | Comparative |
| | | | | | | | | | | Example |
| 17 | 0.0025 | 2.1 | 1.16 | 0.007 | 0.089 | 0.0023 | 0.0031 | 120 | 22 | Comparative |
| | | | | | | | | | | Example |
| 18 | 0.0078 | 1.4 | 1.59 | 0.008 | 0.130 | 0.0014 | 0.0018 | 55 | 16 | Comparative |
| | | | | | | | | | | Example |
| 19 | 0.0510 | 1.3 | 0.55 | 0.005 | 0.033 | 0.0024 | 0.0014 | 20 | 11 | Comparative |
| | | | | | | | | | | Example |

TABLE 4

| | | Anhysteretic | Coercive | | |
|---|---|---|---|---|---|
| | YS | Magnetic | Force | Welding | |
| No. | (N/mm²) | Permeability | (A/m) | Properties | Remarks |
| 11 | 360 | 16,000 | 167 | ◯ | Present |
| | | | | | Invention |
| 12 | 380 | 16,500 | 175 | ◯ | Present |
| | | | | | Invention |
| 13 | 395 | 17,000 | 152 | ◯ | Present |
| | | | | | Invention |
| 14 | 423 | 17,500 | 145 | ◯ | Present |
| | | | | | Invention |
| 15 | 444 | 18,000 | 136 | ◯ | Present |
| | | | | | Invention |
| 16 | 445 | 17,000 | 112 | X | Comparative |
| | | | | | Example |
| 17 | 411 | 16,500 | 120 | X | Comparative |
| | | | | | Example |
| 18 | 406 | 9,500 | 175 | X | Comparative |
| | | | | | Example |
| 19 | 436 | 15,500 | 285 | ◯ | Comparative |
| | | | | | Example |

### Third Example

Each of steel samples Nos. 21 to 26 having a chemical composition as shown in Table 5 was smelted and, then, was cast into a slab. An electromagnetic strirring was performed in the casting stage. The slab thus prepared was hot-rolled so as to obtain a hot rolled coil having a thickness of 2.8 mm. The finish rolling temperature was set at 870° C. Also, the wind-up temperature after the finish rolling was set at 680° C. Incidentally, the electromagnetic stirring was not performed in the casting stage of sample No. 24.

A hot rolled sheet annealing was applied at 700° C. to the hot rolled coil thus obtained, followed by applying an acid pickling, then, a cold rolling so as to obtain a cold rolled steel sheet having a thickness of 1.0 mm. The cold rolled steel sheet thus obtained was annealed at 700° C. for 60 seconds so as to obtain a steel sheet sample.

The steel sheet sample was heated at 500° C. for 60 seconds and, then, a sample was cut out of the steel sheet sample thus obtained so as to measure the yield strength as well as the anhysteretic magnetic permeability. The anhysteretic magnetic permeability was measured when a demagnetization process was performed by superimposing an offset magnetic field of 27.9 A/m (0.35 Oe). The anhysteretic magnetic permeability was measured as in the first Example.

For determining the change with time in the anhysteretic magnetic permeability, which is denoted by Δμan, a sample having an anhysteretic magnetic permeability thereof measured in advance was subjected to an aging treatment at 100° C. for 11 hours, followed by measuring again the anhysteretic magnetic permeability. The value of Δμan (change with time in the anhysteretic magnetic permeability) was obtained by the formula “Δμan=A−B”, where A denotes the anhysteretic magnetic permeability after the aging treatment, and B denotes the anhysteretic magnetic permeability before the aging treatment.

The welding properties were also evaluated in respect of the steel sheet sample. For evaluating the welding properties, four annealed steel sheets were superposed one upon the other, and a spot welding was applied to the superposed structure as in the first Example so as to evaluate the welding properties on the basis equal to that in the first Example.

Table 6 shows the results of measurement of the yield strength (YS) and the anhysteretic magnetic permeability as well as the results of evaluations of the change with time in the anhysteretic magnetic permeability and the welding properties.

As shown in Table 6, each of steel sheet samples Nos. 21, 22 and 23, which had the composition, the P segregation rate and the texture falling within the ranges specified in the third embodiment of the present invention, exhibited a high yield strength not lower than 340 N/mm², and a high anhysteretic magnetic permeability not lower than 7,000, with the result that each of these steel sheet samples was found to be satisfactory in the magnetic shielding properties. Each of these steel sheet samples also exhibits a small AI (aging index) value not larger than 90 N/mm², with the result that each of these steel sheet samples was small in the deterioration with time in the anhysteretic magnetic permeability and was satisfactory in the welding properties. On the other hand, the steel sheet samples Nos. 24, 25 and 26, in which the P segregation rate exceeded the upper limit specified in the present invention, the P content exceeded the upper limit specified in the present invention or the C content exceeded the upper limit specified in the present invention, were found to be unsatisfactory in at least one of the magnetic properties, the deterioration with time of the magnetic properties, and the welding properties.

As pointed out above, it has been confirmed that a steel sheet exhibiting an expected yield strength, expected magnetic properties (anhysteretic magnetic permeability) and expected welding properties can be provided in the case of satisfying the required constituents of the present invention defined in the third embodiment of the present invention. In addition, it is possible to suppress the deterioration with time of the magnetic properties (anhysteretic magnetic permeability) in the case of satisfying the required constituents of the present invention defined in the third embodiment of the present invention.

TABLE 5

| | | | | | | | | P | Ferrite | | |
|---|---|---|---|---|---|---|---|---|---|---|---|
| | | | | | | | | Segregation | Grain | | |
| Steel | Chemical Composition (mass %) | | | | | | | Rate | Size | AI | |
| No. | | Si | Mn | S | P | O | N | (%) | (μm) | (N/mm²) | Remarks |
| 21 | 0.0020 | 0.51 | 2.32 | 0.005 | 0.076 | 0.0022 | 0.0027 | 52 | 15 | 74 | Present |
| | | | | | | | | | | | Invention |
| 22 | 0.0150 | 0.50 | 0.98 | 0.007 | 0.075 | 0.0020 | 0.0020 | 30 | 11 | 80 | Present |
| | | | | | | | | | | | Invention |
| 23 | 0.0084 | 0.96 | 1.62 | 0.008 | 0.061 | 0.0016 | 0.0030 | 33 | 12 | 76 | Present |
| | | | | | | | | | | | Invention |
| 24 | 0.0021 | 0.55 | 2.25 | 0.008 | 0.082 | 0.0024 | 0.0025 | 121 | 12 | 75 | Comparative |
| | | | | | | | | | | | Example |
| 25 | 0.0023 | 0.53 | 2.12 | 0.007 | 0.160 | 0.0017 | 0.0015 | 95 | 13 | 77 | Comparative |
| | | | | | | | | | | | Example |
| 26 | 0.22 | 0.98 | 1.63 | 0.008 | 0.066 | 0.0017 | 0.0031 | 42 | 10 | 95 | Comparative |
| | | | | | | | | | | | Example |

TABLE 6

| | | | Change with | | |
|---|---|---|---|---|---|
| | | | Time in | | |
| | | Anhysteretic | Anhysteretic | | |
| | | Magnetic | Magnetic | | |
| Steel | YS | Permeability | Permeability | Welding | |
| No. | (N/mm²) | μ an | Δ μ an | Properties | Remarks |
| 21 | 411 | 14,800 | −1,000 | ◯ | Present |
| | | | | | Invention |
| 22 | 352 | 13,400 | −1,500 | ◯ | Present |
| | | | | | Invention |
| 23 | 408 | 14,000 | −1,200 | ◯ | Present |
| | | | | | Invention |
| 24 | 412 | 14,300 | −1,200 | X | Comparative |
| | | | | | Example |
| 25 | 436 | 6,800 | −1,800 | X | Comparative |
| | | | | | Example |
| 26 | 440 | 10,000 | −2,500 | ◯ | Comparative |
| | | | | | Example |

### Fourth Example

Each of steel samples Nos. 31 to 35 having a chemical composition including an additional component of B as shown in Table 7 was smelted and, then, the melt was cast into a slab. An electromagnetic stirring was performed in the casting stage. The slab thus prepared was hot-rolled so as to obtain a hot rolled coil having a thickness of 2.8 mm. The finish rolling temperature was set at 870° C. Also, the wind-up temperature after the finish rolling was set at 680° C. Incidentally, the electromagnetic stirring was not performed in the casting stage of sample No. 34.

A hot rolled sheet annealing was applied at 700° C. to the hot rolled coil thus obtained, followed by applying an acid pickling and, then, a cold rolling so as to obtain a cold rolled steel sheet having a thickness of 1.0 mm. The cold rolled steel sheet thus obtained was annealed at 700° C. for 60 seconds so as to obtain a steel sheet sample.

A sample was cut out of the steel sheet sample thus obtained so as to measure the yield strength as well as the anhysteretic magnetic permeability. The anhysteretic magnetic permeability was measured when a demagnetization process was performed by superimposing an offset magnetic field of 27.9 A/m (0.35 Oe) as in the first Example. Also, a sample having an anhysteretic magnetic permeability thereof measured in advance was subjected to an aging treatment at 100° C. for 11 hours, followed by measuring again the anhysteretic magnetic permeability so as to determine the change with time in the anhysteretic magnetic permeability, which is denoted by Δμan as in the third Example.

The welding properties were also evaluated in respect of the steel sheet sample. For evaluating the welding properties, four annealed steel sheets were superposed one upon the other, and a spot welding was applied to the superposed structure as in the first Example so as to evaluate the welding properties on the basis equal to that in the first Example.

Table 8 shows the results of measurement of the yield strength (YS) and the anhysteretic magnetic permeability as well as the results of evaluations of the change with time in the anhysteretic magnetic permeability and the welding properties.

As shown in Table 8, each of steel sheet samples Nos. 31, 32 and 33, which had the composition, the P segregation rate and the texture falling within the ranges specified in the fourth embodiment of the present invention, exhibited a high yield strength not lower than 340 N/mm², and a high anhysteretic magnetic permeability not lower than 7,000, with the result that each of these steel sheet samples was found to be satisfactory in the magnetic shielding properties and the welding properties. Also, the B addition has rendered the value of AI (aging index) for these steel sheet samples Nos. 31, 32, 33 smaller than that for the steel sheet samples Nos. 21, 22, 23 for the third Example. On the other hand, the steel sheet samples Nos. 34 and 35, in which the P segregation rate exceeded the upper limit specified in the present invention and the P content exceeded the upper limit specified in the present invention, were found to be unsatisfactory in at least one of the magnetic properties and the welding properties.

As pointed out above, it has been confirmed that a steel sheet exhibiting an expected yield strength, expected magnetic properties (anhysteretic magnetic permeability) and expected welding properties can be provided in the case of satisfying the required constituents of the present invention defined in the fourth embodiment of the present invention. In addition, in the case of satisfying the required constituents of the present invention defined in the fourth embodiment of the present invention, it is possible to suppress the deterioration with time of the magnetic properties (anhysteretic magnetic permeability) more effectively as compared with the third embodiment.

TABLE 7

| | | | | | | | | | P | Ferrite | | |
|---|---|---|---|---|---|---|---|---|---|---|---|---|
| | | | | | | | | | Segregation | Grain | | |
| Steel | Chemical Composition (mass %) | | | | | | | | Rate | Size | AI | |
| No. | C | Si | Mn | S | P | O | N | B | (%) | (μm) | (N/mm²) | Remarks |
| 31 | 0.0023 | 0.50 | 2.30 | 0.005 | 0.074 | 0.0024 | 0.0023 | 0.0030 | 48 | 16 | 55 | Present |
| | | | | | | | | | | | | Invention |
| 32 | 0.0151 | 0.49 | 0.97 | 0.006 | 0.077 | 0.0021 | 0.0021 | 0.0025 | 31 | 10 | 50 | Present |
| | | | | | | | | | | | | Invention |
| 33 | 0.0085 | 0.98 | 1.61 | 0.007 | 0.060 | 0.0017 | 0.0032 | 0.0027 | 32 | 12 | 60 | Present |
| | | | | | | | | | | | | Invention |
| 34 | 0.0024 | 0.57 | 2.24 | 0.009 | 0.083 | 0.0020 | 0.0021 | 0.0021 | 125 | 13 | 55 | Comparative |
| | | | | | | | | | | | | Example |
| 35 | 0.0024 | 0.54 | 2.13 | 0.008 | 0.161 | 0.0015 | 0.0014 | 0.0011 | 93 | 14 | 57 | Comparative |
| | | | | | | | | | | | | Example |

TABLE 8

| | | | Change with | | |
|---|---|---|---|---|---|
| | | | Time in | | |
| | | Anhysteretic | Anhysteretic | | |
| | | Magnetic | Magnetic | | |
| Steel | YS | Permeability | Permeability | Welding | |
| No. | (N/mm²) | μ an | Δ μ an | Properties | Remarks |
| 31 | 410 | 14,900 | −500 | ◯ | Present |
| | | | | | Invention |
| 32 | 350 | 13,500 | −1,000 | ◯ | Present |
| | | | | | Invention |
| 33 | 409 | 14,100 | −700 | ◯ | Present |
| | | | | | Invention |
| 34 | 411 | 14,400 | −500 | X | Comparative |
| | | | | | Example |
| 35 | 435 | 9,300 | −500 | X | Comparative |
| | | | | | Example |

### Fifth Example

Each of steel samples Nos. 41 to 49 having a chemical composition as shown in Table 9 was smelted and, then, was cast into a slab. An electromagnetic stirring was performed in the casting stage. The slab thus prepared was hot-rolled so as to obtain a hot rolled coil having a thickness of 2.8 mm. The finish rolling temperature was set at 870° C. Also, the wind-up temperature after the finish rolling was set at 680° C. Incidentally, the electromagnetic stirring was not performed in the casting stage of sample No. 47.

A hot rolled sheet annealing was applied at 700° C. to the hot rolled coil thus obtained, followed by applying an acid pickling and, then, a cold rolling so as to obtain a cold rolled steel sheet having a thickness of 1.0 mm. The cold rolled steel sheet thus obtained was annealed at 700° C. for 60 seconds so as to obtain a steel sheet sample.

The steel sheet sample was heated at 500° C. for 60 seconds and, then, a sample was cut out of the steel sheet sample thus obtained so as to measure the yield strength as well as the anhysteretic magnetic permeability, the coercive force, and the change with time in the coercive force. The anhysteretic magnetic permeability was measured when a demagnetization process was performed by superimposing an offset magnetic field of 27.9 A/m (0.35 Oe). The anhysteretic magnetic permeability was measured as in the first Example.

For determining the change with time in the coercive force, which is denoted by ΔHc, a sample having the coercive force thereof measured in advance was subjected to an aging treatment at 100° C. for 11 hours, followed by measuring again the coercive force. The value of ΔHc (change with time in the coercive force) was obtained by the formula “ΔHc=M−N”, where M denotes the coercive force after the aging treatment, and N denotes the coercive force before the aging treatment.

The welding properties were also evaluated in respect of the steel sheet sample. For evaluating the welding properties, four annealed steel sheets were superposed one upon the other, and a spot welding was applied to the superposed structure as in the first Example so as to evaluate the welding properties on the basis equal to that in the first Example.

Table 10 shows the results of measurement of the yield strength (YS), the anhysteretic magnetic permeability, and the coercive force as well as the results of evaluations of the change with time in the coercive force and the welding properties.

As shown in Table 10, each of steel sheet samples Nos. 41 to 45, which had the composition, the P segregation rate and the texture falling within the ranges specified in the present invention, exhibited a high yield strength not lower than 340 N/mm², a high anhysteretic magnetic permeability not lower than 7,000, and a small coercive force smaller than 240 A/m, with the result that each of these steel sheet samples was found to be satisfactory in the magnetic shielding properties. Each of these steel sheet samples also exhibits a small AI (aging index) value not larger than 90 N/mm², with the result that each of these steel sheet samples was small in the deterioration with time in the coercive force and was satisfactory in the welding properties. On the other hand, the steel sheet sample No. 46, in which the Si content exceeded the upper limit specified in th fifth embodiment of the present invention, the steel sheet sample 47, in which the P segregation rate exceeded the upper limit specified in the present invention, the steel sheet sample No. 48, in which the P content exceeded the upper limit specified in the present invention, and the steel sheet sample No. 49, in which the C content exceeded the upper limit specified in the fifth embodiment of the present invention, were found to be unsatisfactory in at least one of the magnetic properties, the change with time in the magnetic properties, and the welding properties.

As pointed out above, it has been confirmed that a steel sheet exhibiting an expected yield strength, expected magnetic properties (anhysteretic magnetic permeability and coercive force) and expected welding properties can be provided in the case of satisfying the required constituents of the present invention defined in the fifth embodiment of the present invention. In addition, it is possible to suppress the deterioration with time of the magnetic properties (coercive force) in the case of satisfying the required constituents of the present invention defined in the fifth embodiment of the present invention.

TABLE 9

| | | | | | | | | P | Ferrite | | |
|---|---|---|---|---|---|---|---|---|---|---|---|
| | | | | | | | | Segregation | Grain | | |
| Steel | Chemical Composition (mass %) | | | | | | | Rate | Size | AI | |
| No. | C | Si | Mn | S | P | O | N | (%) | (μm) | (N/mm²) | Remarks |
| 41 | 0.0139 | 1.4 | 2.16 | 0.005 | 0.079 | 0.0018 | 0.0017 | 35 | 16 | 72 | Present |
| | | | | | | | | | | | Invention |
| 42 | 0.0205 | 1.4 | 2.17 | 0.006 | 0.085 | 0.0020 | 0.0019 | 35 | 15 | 75 | Present |
| | | | | | | | | | | | Invention |
| 43 | 0.0068 | 1.7 | 1.95 | 0.005 | 0.062 | 0.0017 | 0.0022 | 40 | 20 | 73 | Present |
| | | | | | | | | | | | Invention |
| 44 | 0.0053 | 1.8 | 1.85 | 0.007 | 0.059 | 0.0013 | 0.0025 | 45 | 21 | 75 | Present |
| | | | | | | | | | | | Invention |
| 45 | 0.0070 | 2.8 | 0.45 | 0.008 | 0.025 | 0.0015 | 0.0022 | 30 | 22 | 80 | Present |
| | | | | | | | | | | | Invention |
| 46 | 0.0029 | 3.1 | 0.25 | 0.006 | 0.023 | 0.0012 | 0.0016 | 25 | 24 | 71 | Comparative |
| | | | | | | | | | | | Example |
| 47 | 0.0023 | 2.0 | 1.18 | 0.007 | 0.090 | 0.0021 | 0.0029 | 115 | 23 | 73 | Comparative |
| | | | | | | | | | | | Example |
| 48 | 0.0081 | 1.3 | 1.52 | 0.005 | 0.110 | 0.0014 | 0.0018 | 60 | 17 | 75 | Comparative |
| | | | | | | | | | | | Example |
| 49 | 0.21 | 1.2 | 0.45 | 0.006 | 0.025 | 0.0025 | 0.0023 | 20 | 12 | 93 | Comparative |
| | | | | | | | | | | | Example |

TABLE 10

| | | | | Change | | |
|---|---|---|---|---|---|---|
| | | | | with Time in | | |
| | | Anhysteretic | Coercive | Coercive | | |
| | | Magnetic | Force | Force | | |
| Steel | YS | Permeability | Hc | Δ Hc | Welding | |
| No. | (N/mm²) | μ an | (A/m) | (A/m) | Properties | Remarks |
| 41 | 385 | 16,000 | 185 | +29 | ◯ | Present |
| | | | | | | Invention |
| 42 | 378 | 16,500 | 198 | +37 | ◯ | Present |
| | | | | | | Invention |
| 43 | 402 | 17,000 | 147 | +25 | ◯ | Present |
| | | | | | | Invention |
| 44 | 397 | 17,500 | 145 | +23 | ◯ | Present |
| | | | | | | Invention |
| 45 | 442 | 17,500 | 132 | +26 | ◯ | Present |
| | | | | | | Invention |
| 46 | 459 | 17,000 | 109 | +12 | X | Comparative |
| | | | | | | Example |
| 47 | 410 | 16,500 | 116 | +16 | X | Comparative |
| | | | | | | Example |
| 48 | 396 | 9,500 | 172 | +30 | X | Comparative |
| | | | | | | Example |
| 49 | 442 | 9,000 | 225 | +50 | ◯ | Comparative |
| | | | | | | Example |

### Sixth Example

Each of steel samples Nos. 51 to 53 having a chemical composition including an additional component of B as shown in Table 11 was smelted and, then, was cast into a slab. An electromagnetic stirring was performed in the casting stage. The slab thus prepared was hot-rolled so as to obtain a hot rolled coil having a thickness of 2.8 mm. The finish rolling temperature was set at 870° C. Also, the wind-up temperature after the finish rolling was set at 680° C.

A hot rolled sheet annealing was applied at 700° C. to the hot rolled coil thus obtained, followed by applying an acid pickling and, then, a cold rolling so as to obtain a cold rolled steel sheet having a thickness of 1.0 mm. The cold rolled steel sheet thus obtained was annealed at 700° C. for 60 seconds so as to obtain a steel sheet sample.

The steel sheet sample thus obtained was heated at 500° C. for 60 seconds and, then, a sample was cut out of the steel sheet sample thus obtained so as to measure the anhysteretic magnetic permeability and the coercive force. The anhysteretic magnetic permeability was measured when a demagnetization process was performed by superimposing an offset magnetic field of 27.9 A/m (0.35 Oe) as in the fifth Example. Also, a sample having an coercive force thereof measured in advance was subjected to an aging treatment at 100° C. for 11 hours, followed by measuring again the coercive force so as to determine the change with time in the coercive force, which is denoted by ΔHc as in the fifth Example.

The welding properties were also evaluated in respect of the steel sheet sample. For evaluating the welding properties, four annealed steel sheets were superposed one upon the other, and a spot welding was applied to the superposed structure as in the first Example so as to evaluate the welding properties on the basis equal to that in the first Example.

Table 12 shows the results of measurement of the yield strength (YS), the anhysteretic magnetic permeability, and the coercive force as well as the results of evaluations of the change with time in the coercive force and the welding properties.

As shown in Table 12, each of steel sheet samples Nos. 51 to 53, which had the composition, the P segregation rate and the texture falling within the ranges specified in the sixth embodiment of the present invention, exhibited a high yield strength not lower than 340 N/mm², a high anhysteretic magnetic permeability not lower than 7,000, and a small coercive force smaller than 240 A/m, with the result that each of these steel sheet samples was found to be satisfactory in the magnetic shielding properties and the welding properties. Also, the B addition has rendered the value of AI (aging index) for these steel sheet samples Nos. 51 to 53 smaller than that for the steel sheet samples Nos. 41 to 45 for the forth Example. Also, the deterioration with time of the coercive force was found to be small.

As pointed out above, it has been confirmed that a steel sheet exhibiting an expected yield strength, expected magnetic properties (anhysteretic magnetic permeability and coercive force) and expected welding properties can be provided in the case of satisfying the required constituents of the present invention defined in the sixth embodiment of the present invention. In addition, in the case of satisfying the required constituents of the present invention defined in the sixth embodiment of the present invention, it is possible to suppress the deterioration with time of the magnetic properties (coercive force) more effectively as compared with the fifth embodiment

TABLE 11

| | | | | | | | | | P | Ferrite | | |
|---|---|---|---|---|---|---|---|---|---|---|---|---|
| | | | | | | | | | Segregation | Grain | | |
| Steel | Chemical Composition (mass %) | | | | | | | | Rate | Size | AI | |
| No. | C | Si | Mn | S | P | O | N | B | (%) | (μm) | (N/mm²) | Remarks |
| 51 | 0.0120 | 1.3 | 2.00 | 0.005 | 0.080 | 0.0021 | 0.0020 | 0.0025 | 30 | 16 | 65 | Present |
| | | | | | | | | | | | | Invention |
| 52 | 0.0208 | 1.2 | 2.10 | 0.006 | 0.085 | 0.0022 | 0.0015 | 0.0018 | 38 | 15 | 63 | Present |
| | | | | | | | | | | | | Invention |
| 53 | 0.0065 | 1.6 | 1.90 | 0.005 | 0.060 | 0.0018 | 0.0025 | 0.0028 | 40 | 18 | 60 | Present |
| | | | | | | | | | | | | Invention |

TABLE 12

| | | | | Change with | | |
|---|---|---|---|---|---|---|
| | | | | Time in | | |
| | | Anhysteretic | Coercive | Coercive | | |
| | | Magnetic | Force | Force | | |
| Steel | YS | Permeability | Hc | Δ Hc | Welding | |
| No. | (N/mm²) | μ an | (A/m) | (A/m) | Properties | Remarks |
| 51 | 390 | 16,500 | 180 | +10 | ◯ | Present |
| | | | | | | Invention |
| 52 | 375 | 16,500 | 193 | +16 | ◯ | Present |
| | | | | | | Invention |
| 53 | 400 | 17,000 | 143 | +15 | ◯ | Present |
| | | | | | | Invention |

### APPLICABILITY IN THE INDUSTRY

According to the present invention, it is possible to obtain a steel sheet for an explosion-proof band having a high mechanical strength, which is excellent in its welding properties and its magnetic properties, and to obtain a steel sheet for an explosion-proof band having a high mechanical strength, which is small in the change with time in the magnetic properties in addition to the excellent properties described above. Naturally, the present invention produces prominent effects useful in the industries.

1. A steel sheet for an explosion-proof band having a high mechanical strength and excellent in magnetic properties and welding properties, said steel sheet containing 0.001 to 0.05% by mass of C, 0.2 to 1% by mass of Si, 0.5 to 2.3% by mass of Mn, 0.02 to 0.12% by mass of P, not higher than 0.005% by mass of O, not higher than 0.020% by mass of S, and not higher than 0.005% by mass of N, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 10 to 25 μm of an average ferrite grain size, and not lower than 10,000 of an anhysteretic magnetic permeability.

2. A steel sheet for an explosion-proof band having a high mechanical strength and excellent in magnetic properties and welding properties, said steel sheet containing 0.001 to 0.05% by mass of C, more than 1% by mass to 3% by mass of Si, 0.2 to 2.5% by mass of Mn, 0.02 to 0.12% by mass of P, not higher than 0.005% by mass of O not higher than 0.020% by mass of S, and not higher than 0.005% by mass of N, and having not lower than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 10 to 25 μm of an average ferrite grain size, and not lower than 10,000 of an anhysteretic magnetic permeability.

3. A steel sheet for an explosion-proof band having a high mechanical strength, excellent in magnetic properties and welding properties, and low in the deterioration with time of the magnetic properties, said steel sheet containing 0.001 to 0.2% by mass of C, 0.2 to 1% by mass of Si, 0.5 to 2.3% by mass of Mn, 0.02 to 0.15% by mass of P, not higher than 0.005% by mass of O, not higher than 0.03% by mass of S, and not higher than 0.01% by mass of N, and having not lower than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500□ for 60 seconds, and not higher than 90 N/mm² of an aging index AI.

4. A steel sheet for an explosion-proof band having a high mechanical strength, excellent in welding properties and magnetic properties, and small in the deterioration with time of the magnetic properties, said steel sheet containing 0.001 to 0.2% by mass of C, 0.2 to 1% by mass of Si, 0.5 to 2.3% by mass of Mn, 0.02 to 0.15% by mass of P, not higher than 0.005% by mass of O, not higher than 0.03% by mass of S, and not higher than 0.01% by mass of N, and 0.0001 to 0.01% by mass of B, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500□ for 60 seconds, and not higher than 70 N/mm² of an aging index AI.

5. A steel sheet for an explosion-proof band having a high mechanical strength, excellent in welding properties and magnetic properties, and low in the deterioration with time of the magnetic properties, said steel sheet containing 0.001 to 0.2% by mass of C, higher than 1% by mass to 3% by mass of Si, 0.2 to 2.5% by mass of Mn, 0.02 to 0.12% by mass of P, not higher than 0.005% by mass of O, not higher than 0.020% by mass of S, and not higher than 0.01% by mass of N, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500□ for 60 seconds, and not higher than 90 N/mm² of an aging index AI.

6. A steel sheet for an explosion-proof band having a high mechanical strength, excellent in welding properties and magnetic properties, and low in the deterioration with time of the magnetic properties, said steel sheet containing 0.001 to 0.2% by mass of C, higher than 1% by mass to 3% by mass of Si, 0.2 to 2.5% by mass of Mn, 0.02 to 0.12% by mass of P, not higher than 0.005% by mass of O, not higher than 0.020% by mass of S, not higher than 0.01% by mass of N, and 0.0001 to 0.01% by mass of B, and having not higher than 100% of a P segregation rate within the steel sheet, which is represented by (Pₘₐₓ−Pₐᵥₑ)×100/Pₐᵥₑ, where Pₘₐₓ denotes the maximum P concentration within the steel sheet, and Pₐᵥₑ denotes the average P concentration within the steel sheet, 5 to 25 μm of an average ferrite grain size, not lower than 7,000 of an anhysteretic magnetic permeability after heating at 500□ for 60 seconds, and not higher than 70 N/mm² of an aging index AI.

7. An explosion-proof band having a high mechanical strength, which is formed from a steel sheet according to claim 1.

8. An explosion-proof band having a high mechanical strength, which is formed from a steel sheet according to claim 2.

9. An explosion-proof band having a high mechanical strength, which is formed from a steel sheet according to claim 3.

10. An explosion-proof band having a high mechanical strength, which is formed from a steel sheet according to claim 4.

11. An explosion-proof band having a high mechanical strength, which is formed from a steel sheet according to claim 5.

12. An explosion-proof band having a high mechanical strength, which is formed from a steel sheet according to claim 6.
